(19) United States
(12) Patent Application Publication
(10) Pub. No.: US 2010/0014288 A1
(43) Pub. Date: Jan. 21, 2010

(54) RETRO-FIT LIGHT STICK DEVICE AND SECONDARY LIGHT SOURCE OR OTHER ELECTRICAL DEVICE FOR USE WITH WALK-IN TYPE COOLERS AND OTHER PRODUCT DISPLAY UNITS

(75) Inventors: Robert E. Kreutzer, Columbia, IL (US); Donald J. Miller, JR., Belleville, IL (US)

Correspondence Address: HUSCH BLACKWELL SANDERS LLP, 190 Carondelet Plaza, Suite 600, ST. LOUIS, MO, 63105, US

(73) Assignee: PRESENCE FROM INNOVATION, LLC, St. Louis, MO (US)

(21) Appl. No.: 12/502,837

(22) Filed: Jul. 14, 2009

Related U.S. Application Data
(60) Provisional application No. 61/080,835, filed on Jul. 15, 2008.
(60) Provisional application No. 61/175,724, filed on May 5, 2009.

(51) Int. Cl. F21V 9/00; F21S 4/00; F21V 1/00; B60Q 1/124

(52) U.S. Cl. 362/231; 362/249.02; 362/235; 362/458

(57) ABSTRACT

A light stick device and a secondary light source for use in walk-in coolers and other product display devices. The light stick device is configured for replacing existing fluorescent tubes and includes a body portion, an array of light emitting diodes (LEDs) extending along a length of the body portion, an array of deflectors located such that at least one deflector is positioned between each LED to deflect light therefrom, and an electrical power connection to power the LEDs. The electrical power connection is adapted for use with existing fluorescent tube fixtures located within the walk-in cooler or other display unit. The present light stick device may also include at least one plug-in socket for powering another electrical device including a secondary light source from the present light stick device. The secondary electrical device may be configured to interface between a standard fluorescent tube and its power fixtures to draw power from such fixtures.

### CROSS-REFERENCE TO RELATED APPLICATION

This Non-Provisional Patent Application claims priority to Provisional Patent Application Ser. No. 61/080,835 and Provisional Patent Application Ser. No. 61/175,724.

### BACKGROUND OF THE INVENTION

The present invention relates generally to product merchandising displays and, more particularly, to a light stick device and a secondary light source configured to illuminate merchandise displayed for sale in walk-in type coolers and other product display units. The light stick device is designed to connect to an existing electrical source provided for fluorescent tubes and may further include at least one socket for enabling a second light source or other electrical device to receive power from the light stick device. Alternatively, the secondary light source or other electrical device may be designed to interface between a standard fluorescent tube and its associated power source to draw power from the existing fluorescent tube fixture.

Walk-in product merchandising display coolers are commonly used in retail outlets such as convenience stores and grocery stores to display a wide variety of different types of products to consumers. A walk-in cooler typically includes one or more consumer access doors that open into the store area to allow a consumer access to products from display racks and associated shelving positioned adjacent the access doors. Commonly, the products on the display racks are illuminated by fluorescent tubes positioned around the cooler access doors. Specifically, the fluorescent tubes are positioned between each access door and direct light in all directions including towards the door areas to illuminate the products.

Fluorescent tubes typically contain mercury and are considered detrimental to the environment. Accordingly, there has been a movement to replace fluorescent tubes with lighting that is less environmentally harmful. However, known replacement lighting is not adapted for use with the existing fluorescent tube electrical connections and ballast system associated with walk-in coolers. It is therefore common to require special adaptors and/or to replace the existing fluorescent tube electrical connections to accommodate such replacement lighting. Moreover, the existing fluorescent tubes and the known replacement lighting often do not direct a substantial portion of the light towards the product on the associated shelving and therefore waste a substantial amount of the light produced. In addition, known replacement lighting is not capable of highlighting particular products. Accordingly, the known replacement lighting for fluorescent lighting within walk-in type coolers provides only a minimal amount of illumination to the products.

Thus, there is a need for an improved lighting system for use in walk-in type coolers and the like, wherein the lighting is adaptable for use with the existing fluorescent fixtures and/or existing fluorescent bulbs within the cooler, and wherein the lighting is capable of achieving maximum illumination on the products displayed therein and capable of highlighting individual products.

### SUMMARY OF THE INVENTION

The present invention provides a light stick device and system for use in a typical walk-in cooler or other product display units. One embodiment of the present light stick device is intended to be used as a retro-fit to replace the existing fluorescent tubes in a typical walk-in cooler and includes a body portion having an array of light emitting diodes (LEDs) extending along a length thereof, wherein the LEDs are configured to illuminate product positioned within a door area of the walk-in cooler. Typically, the LEDs are side emitting LEDs. An array of deflectors are positioned between each adjacent side-emitting LED to deflect light from the LEDs to maximize the use of available light, and an electrical power connection is provided to power the LEDs from an exiting fluorescent fixture in the walk-in cooler. In one embodiment, the array of deflectors deflect light to each of two sides of the light stick device. In another embodiment, the array of deflectors deflect light to one of two sides of the light stick device. Because the LEDs are side emitting LEDs, light is directed to the products positioned within the cooler both from the LEDs themselves and from light deflected by the array of deflectors.

In another embodiment, the light stick device has three faces and a generally triangular cross section when viewed across its transverse axis. In such an embodiment, two of the three faces include an array of LEDs extending along the length thereof. When placed between two display cases, the triangular shape of the light stick device inherently angles the two faces which include the arrays of LEDs toward the display cases, one toward the display case to the left and one toward the display case to the right. A cover which has a generally circular transverse cross section is then positioned such that it circumscribes the triangular transverse cross section of the light stick device. This cover may have additional optical elements which help to focus the light from the LED arrays toward the display cases.

Conversion from an existing fluorescent tube to the present light stick device can be easily accomplished by simply removing the fluorescent tube and plugging the present light stick device into the same existing fluorescent tube fixture. No electrician needed. The present light stick device draws its power from the existing cooler fluorescent lighting ballast system.

In the exemplary embodiment illustrated herein, the light stick device also includes at least one plug-in socket positioned thereon to power another light source or other electrical device from the light stick device. This secondary light source or other electrical device plugs into and extends from the light stick device and can be selectively positioned to highlight particular products within the cooler. The at least one plug-in socket draws its power from the present light stick device.

In another embodiment, a secondary light source, having an electrical contact wafer and at least one bulb, and preferably at least one LED, is designed for use in a typical cooler or other product merchandising display unit in which products contained within the cooler or other display unit are illuminated. This secondary light source may also have at least one deflector for deflecting light preferably toward such products. This secondary light source can be selectively positioned to highlight particular products within the cooler or other display and is designed for use in a merchandising display area with a preexisting light source, such as a fluorescent lamp tube. The electrical contact wafer is in electrical communication with the secondary light source, and is installed between the fluorescent lamp and one of the fluorescent lamp power connections such that some of the electrical power intended for the fluorescent lamp is diverted and/or shared with the secondary light source. Thus, the present secondary light source device draws its power from the existing fluorescent lighting system.

In another embodiment, the electrical contact wafer can be associated with any electrical device for use in any type of product display unit. Such an electrical device may be utilized to produce theatrical effects such as different colored lights, flashing lights, moving lights and/or lighting color fades, spotlights, sequencing lights, fog, video, audio and more to draw consumer attention to particular products in the product display unit.

Further areas of applicability of the present invention will become apparent from the detailed description provided hereinafter. It should be understood that the detailed description and specific examples, while indicating several embodiments of the present invention, are intended for purposes of illustration only and are not intended to limit the scope of the invention.

### BRIEF DESCRIPTION OF THE DRAWINGS

The present invention will become more fully understood from the detailed description and the accompanying drawings.

FIG. 1 is a partial rear elevational view of a portion of a typical walk-in display cooler.

FIG. 2 is an exploded view of a light stick device constructed in accordance with the teachings of the present invention for use with the walk-in display cooler shown in FIG. 1.

FIG. 3 is a perspective view of one embodiment of the light stick device shown in FIG. 2.

FIG. 4 is a perspective view of another embodiment of the light stick device shown in FIG. 2.

FIG. 5 is an exploded view of a light stick device with a triangular transverse cross section.

FIG. 6 is a plan view of the light stick device in FIG. 5.

FIG. 7 is a partial rear elevational view of the walk-in display cooler of FIG. 1 having a plurality of the present light stick devices as shown in FIGS. 2-6 installed in place of the fluorescent tubes shown in FIG. 1.

FIG. 8 is a perspective view of a secondary light source that may be used with the light stick devices shown in FIGS. 2-6.

FIG. 9 is a partial rear elevational view of a portion of the walk-in display cooler shown in FIG. 5 including two secondary light sources as shown in FIG. 8.

FIG. 10 is a perspective view of a secondary light source constructed in accordance with the teachings of the present invention for use with an existing fluorescent bulb.

FIG. 11 is an exploded isometric view of one embodiment of the secondary light source of FIG. 10 as interfaced with a standard fluorescent lamp and fixture.

FIG. 12 is a partial rear elevational view of a portion of a walk-in display cooler including two secondary light sources as shown in FIG. 11.

### DETAILED DESCRIPTION

The following description of the preferred embodiment(s) is merely exemplary in nature and is in no way intended to limit the various embodiments of the present invention, its applications, or uses.

Although the present lighting systems will be described with respect to use in a typical walk-in display cooler environment, their uses are not so limited and it is recognized and anticipated that the present light units and systems can be utilized in a wide variety of different applications as will be hereinafter evident. With respect to the reference numbers used in the drawings, like numerals refer to like parts.

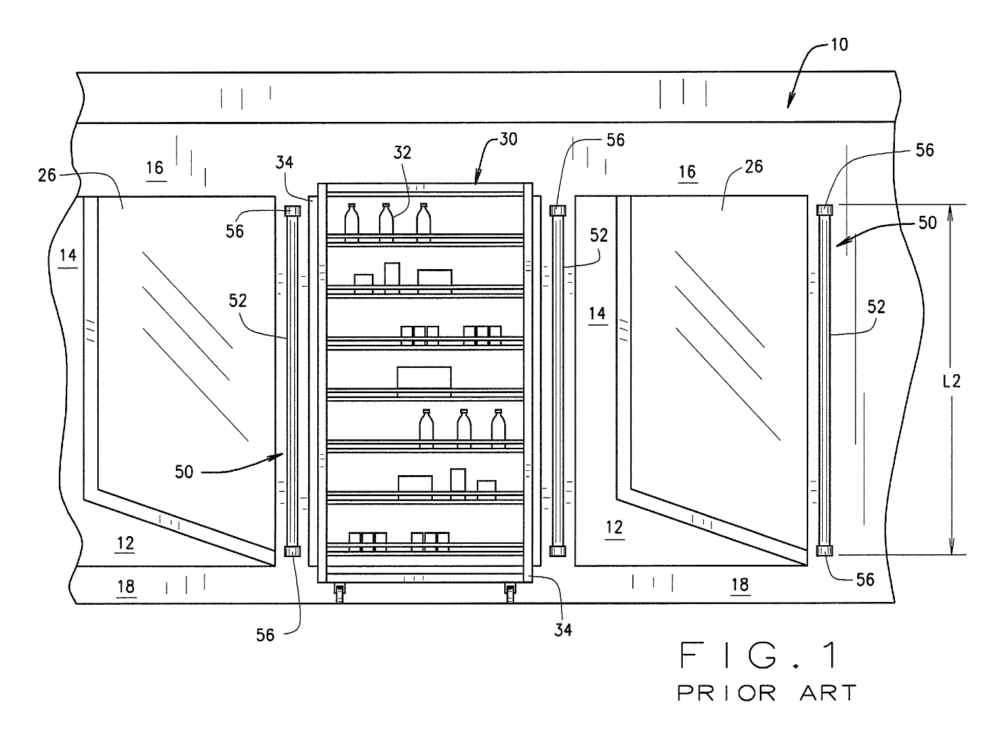

A typical walk-in cooler 10, as illustrated in FIG. 1, includes at least one side wall provided with access doors 26. The access doors 26 can be opened to provide an opening 12 to the area 14 outside the cooler 10. A product merchandising rack 30 is positioned adjacent each opening 12 to display a wide variety of products such as the products 32 that are accessible by customers in the area 14 outside the cooler 10 when the access doors 26 are opened. The product merchandising rack 30 includes a plurality of upright supports 34 and at least one shelf member 36 extending therebetween. The products 32 are positioned on the shelf members 36. Although FIG. 1 only illustrates one product merchandising rack 30, it will be appreciated by one of ordinary skill in the art that a product merchandising rack 30 is typically positioned adjacent each access door 26.

The cooler 10 further includes a prior art lighting system 50 to illuminate the products 32. The prior art lighting system 50 includes at least one fluorescent tube 52 positioned between each access door 26, and one fluorescent tube 52 positioned at each opposite end thereof. Specifically, the fluorescent tubes 52 are vertically positioned adjacent to each access door 26 and a portion of the light emitted from each fluorescent tube 52 is directed to each side to illuminate the product merchandising racks 30 adjacent thereto. Each fluorescent tube 52 is powered by a pair of electrical connections 56 that are permanently installed in the cooler 10. Generally, in known coolers 10, the electrical power connections 56 for fluorescent tubes 52 include a ballast system which is only capable of operating the fluorescent tubes 52.

The above-described cooler 10 is of a type well-known in the art and can be found in a wide variety of retail outlets such as supermarkets, convenience stores, gas stations, grocery stores, and the like. Other embodiments and variations of the cooler 10 are also well known and available in the marketplace.

Notably, the fluorescent tubes 52 used in known coolers 10 have been found to be significantly inefficient and harmful to the environment because of the Mercury contained therein. Further, known fluorescent tubes 52 are not capable of directing all of their light toward the product merchandising rack 30, but instead, because of their cylindrical shape, they emit light in all directions including into and away from the products 32 displayed on the shelves 36 of the product merchandising racks 30. Accordingly, in addition to being inefficient, a significant portion of light from known fluorescent tubes 52 is wasted in known coolers 10.

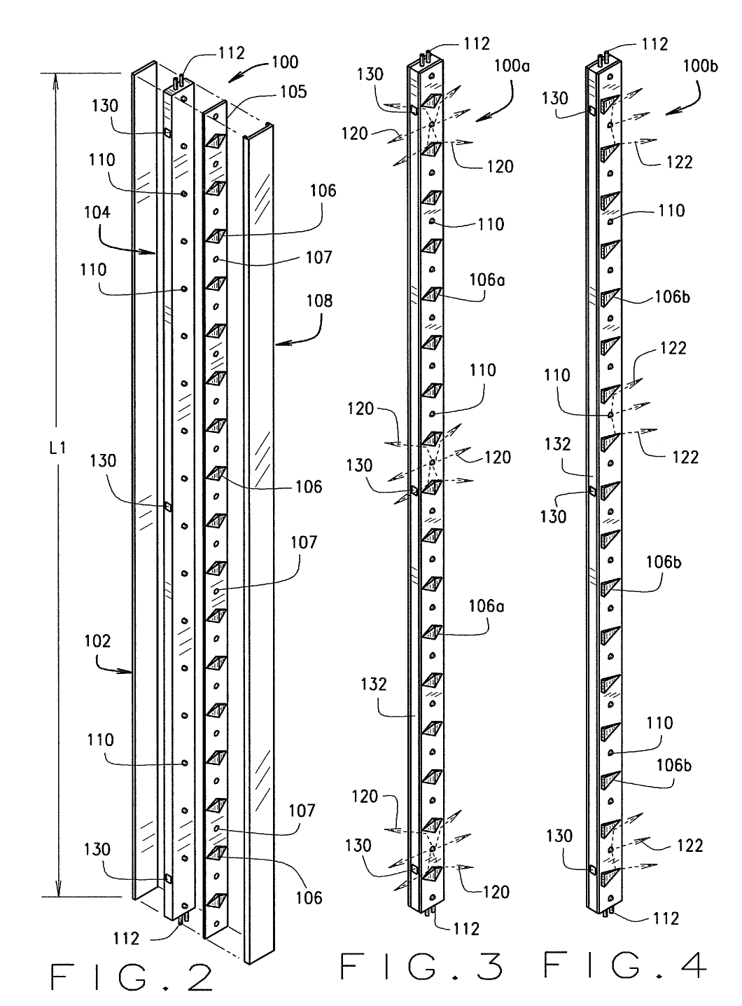

FIG. 2 is an exploded view of an exemplary retro-fit light stick device 100 that may be used to replace the fluorescent tubes 52. The light stick device 100 includes a body portion 102, a printed circuit board 104, LEDs 110, an array of deflectors 106, and a cover 108. The body 102 is fabricated from any material capable of securely supporting an electrical circuit board under conditions such as the low temperatures within the cooler 10. In the exemplary embodiment, the body 102 is rectangular in shape. In this regard, it is recognized and anticipated that the body portion 102, as well as the light stick device 100 in general, can take on any shape that enables the light stick device 100 to function as described herein. Specifically, the body 102 and/or the light stick 100 could have a tubular shape similar to the shape of a fluorescent tube 52 or they could have a triangular or semicircular shape. The body 102 has a length L₁ that is substantially the same length L₂ as the fluorescent tubes 52. Accordingly, the opposite end portions of the assembled light stick device 100 as illustrated in FIGS. 3 and 4 should be configured to be adapted for plugging into the fluorescent electrical power connections 56 associated with the cooler 10 as illustrated in FIG. 5. Although FIGS. 1, 7, and 9 only illustrate electrical power connections 56 that enable the light stick device 100 to be positioned vertically therebetween, it should be understood by one of ordinary skill in the art that the electrical connections 56 may be positioned and located so as to enable the light stick device 100 to be positioned horizontally along the top 16 and/or the bottom 18 of the access door 26.

The printed circuit board 104 is attached to body portion 102 and extends the length L₁ thereof. The printed circuit board 104 includes an array of light emitting diodes (LEDs) 110 that extends the length of the circuit board 104. In the exemplary embodiment, the LEDs 110 are equally spaced in a single row along the circuit board 104 and preferably are side emitting LEDs. In alternative embodiments, the LEDs 110 may have any suitable configuration capable of functioning as described herein. For example, the LEDs 110 may be arranged in two rows extending the length of the circuit board 104, in a zig-zag pattern, or in some other arrangement. The printed circuit board 104 further includes an electrical connection 112 positioned at each end thereof, the electrical connections 112 being configured to functionally couple with the existing electrical fluorescent power connections 56 within the cooler 10 to power the array of LEDs 110. Accordingly, the light stick device 100 is enabled to be retro-fitted into existing coolers 10 without the use of an adaptor and/or a need to replace the existing electrical connections 56.

The array of deflectors 106 are positioned along the length of the circuit board 104. As illustrated in FIGS. 3 and 4, the array of deflectors 106 are positioned along the middle portion of the circuit board 104 such that each deflector 106 is positioned between each adjacent LED 110. In alternative embodiments, the deflectors 106 may be positioned in any configuration suitable for deflecting light from the LEDs 10 to the products 32 as described herein. The body portion 105 which houses or supports the array of deflectors 106 likewise includes a plurality of openings 107 for receiving the LEDs 110 therethrough when the members 104 and 105 are assembled. FIG. 3 illustrates one embodiment of the present light stick device 100a wherein the deflectors 106a have a diamond shaped configuration that is designed to deflect light from the LEDs 110 to both sides of the light stick device 100a as illustrated by the arrows 120. The deflectors 106a in this particular embodiment are used with a light stick device 100a that is disposed between two adjacent access doors 26 so that the light can be deflected toward each door 26 and the corresponding product merchandising rack 30 positioned respectively in front of each door. As will be appreciated by one of ordinary skill in the art, the deflectors 106a may also have a round shape to deflect light towards both sides of the light stick device 100a.

FIG. 4 illustrates another embodiment of the present light stick device 100b wherein the deflectors 106b have a triangular shaped configuration that is designed to deflect light to only one side of the light stick device 100b as illustrated by the arrows 122. The deflectors 106b in this particular embodiment are used with a light stick device 100b that is disposed at an end of the cooler 10 and adjacent only one access door 26 so that the light is deflected only towards the one door 26 and the product merchandising rack 30 positioned in front thereof. The deflectors 106 maximize the amount of light cast onto the product merchandising racks 30 to provide a level of light that is brighter than the light typically cast by a fluorescent tube 52. It is recognized and anticipated that the deflectors 106 may include any optical element, such as flutes, prisms, pillows, lenses or any other such optical element. It is further recognized and anticipated that such deflectors 106 may be located on the body portion 105, on the printed circuit board 104, or on the cover 108 of a light stick device 100.

The cover 108 is positioned over the LEDs 110 and the deflectors 106 to protect the components of the light stick device 100 from the external environment. The cover 108 is transparent to allow the light from the LEDs 110 to pass therethrough.

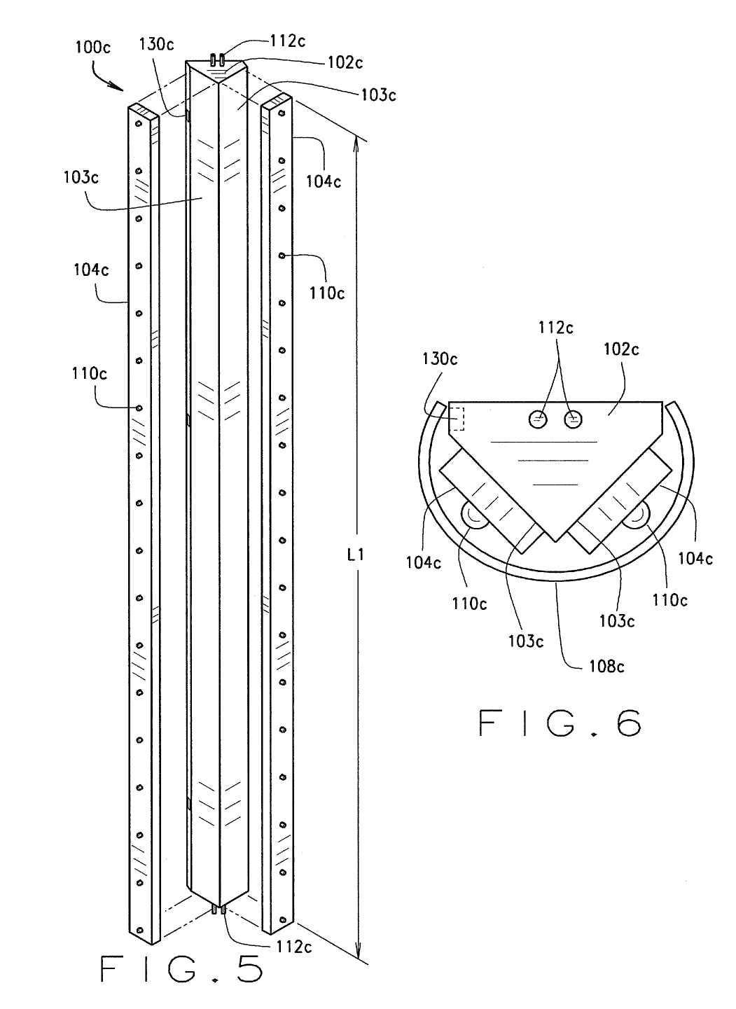

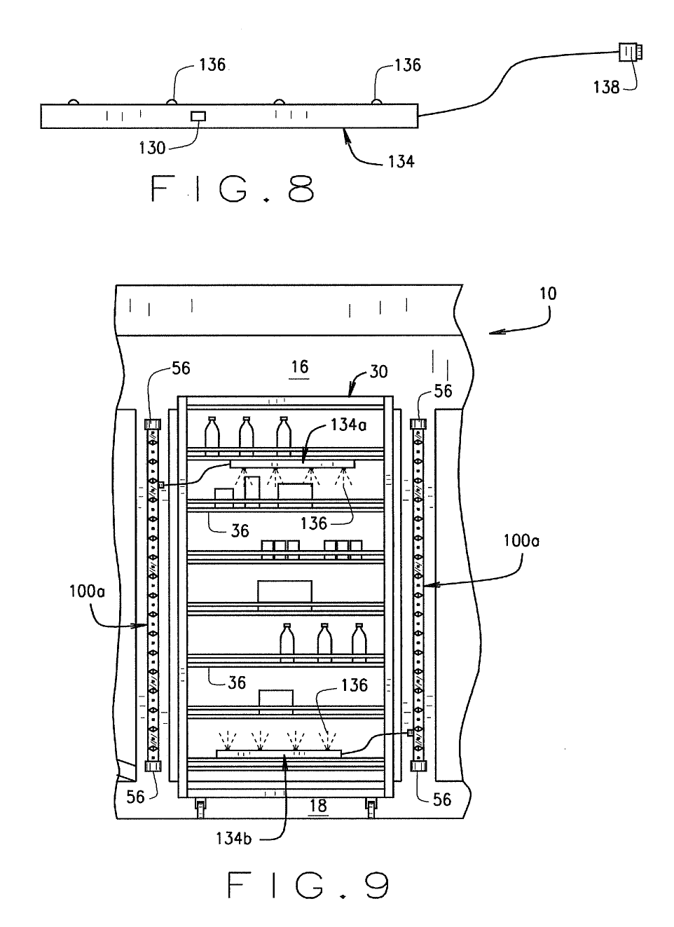

FIG. 5 is an exploded view of an exemplary retro-fit light stick device 100c with a generally triangular transverse cross section that may be used to replace the fluorescent tubes 52. FIG. 6 is plan view of the light stick device 100c of FIG. 8. The light stick device 100c includes an elongate body portion 102c with a generally triangular transverse cross section and two outwardly extending faces 103c, a printed circuit board 104c attached to each outwardly extending face 103c, LEDs 110c, a cover 108c, and may include at least one secondary light stick socket 130c as will be hereinafter explained. The body 102c is fabricated from any material capable of securely supporting an electrical circuit board under conditions such as the low temperatures within the cooler 10. The body 102c has a length L₁ that is substantially the same length L₂ as the fluorescent tubes 52. Accordingly, the opposite end portions of the assembled light stick device 100c as illustrated in FIG. 5 should be configured to be adapted for plugging into the fluorescent electrical power connections 56 associated with the cooler 10 via electrical connections 112c positioned at each end of the body portion 102c. It is noted that a printed circuit board 104c is in electric communication with electrical power connections 112c to supply power to LEDs 110c. Alternatively, printed circuit boards 104c may themselves include electrical connections 112c.

The printed circuit board 104c is attached to each outwardly extending face 103c of body portion 102c and each extends the length L₁ thereof. Each printed circuit board 104c includes an array of LEDs 110c that extends the length of the circuit board 104c. In the exemplary embodiment, the LEDs 110c are equally spaced in a single row along the circuit board 104c. In alternative embodiments, the LEDs 110c may have any suitable configuration capable of functioning as described herein. For example, the LEDs 110c may be arranged in two rows extending the length of the circuit board 104c, in a zig-zag pattern, or in some other arrangement. A cover 108c is then positioned around the body portion 102c, printed circuit boards 104c and LEDs 110c such that the cover 108c has a generally circular transverse cross section which circumscribes the generally triangular cross section of the body portion 102c. Cover 108c may have additional optical elements which serve to help direct or focus more of the light from LEDs 110c toward the product merchandising racks 30. Accordingly, the light stick device 100c is enabled to be retro-fitted into existing coolers 10 without the use of an adaptor and/or a need to replace the existing electrical connections 56. The generally triangular transverse cross sectional shape of body portion 102c serves to orient the printed circuit boards 104c at an angle facing the display racks 30 on either side of the light stick device 100c.

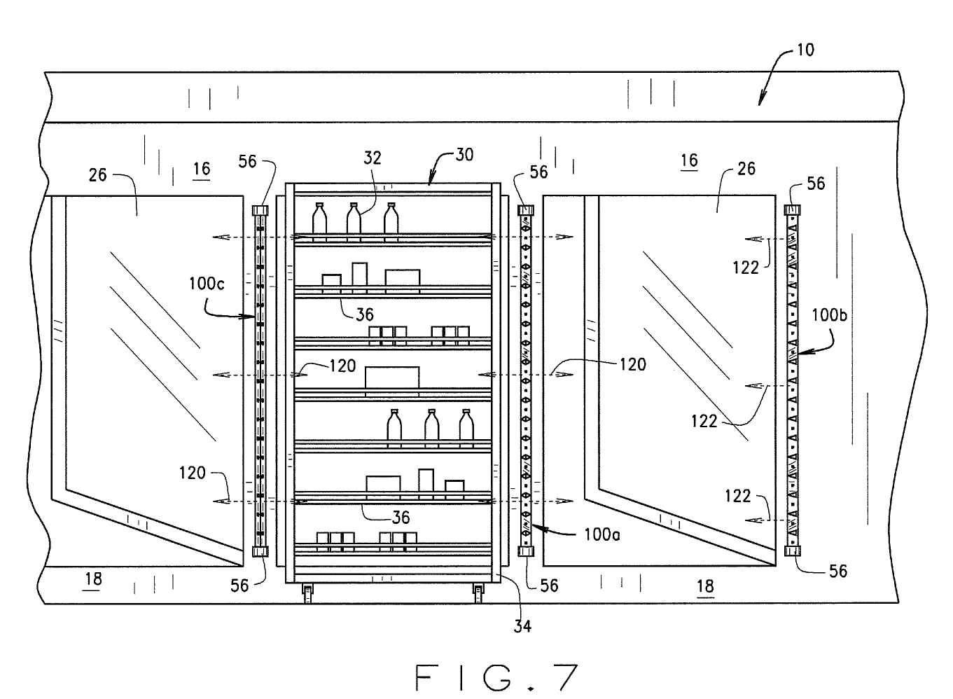

FIG. 7 illustrates the cooler 10 of FIG. 1 retro-fitted with the present light stick devices 100a and 100b. Conversion is simply accomplished by removing the fluorescent tubes 56 from their electrical power connectors 56 and plugging in the present light stick devices 100 into the same electrical connections 56. Light stick devices 100a deflect light towards both adjacent doors 26 and their corresponding associated racks 30 while light stick device 100b deflects light only in the direction of end door 26 and its corresponding associated rack 30.

The light stick devices 100 described above provide a more efficient light system for the cooler 10 and all such devices 100 are capable of being plugged immediately into the existing electrical connections 56. The light stick devices 100 do not require an electrician to update or modify the electrical connections 56, nor do they require an adaptor to fit into the electrical connections 56. Accordingly, the light stick devices 100 can easily replace environmentally harmful fluorescent tubes, while drawing power from the existing electrical system in the cooler. Moreover, the light stick devices 100 more efficiently utilize power from the existing electrical system and the deflectors 106 ensure that a maximum amount of light from the LEDs 110 is cast onto the product merchandising racks 30 thereby increasing the amount of illumination provided to the products 32. Moreover, the light stick devices 100 enable any plurality of secondary light sources 134 to be attached thereto so that individual products 32 can be highlighted within the cooler 10 as will be hereinafter explained. A plurality of electrical devices producing theatrical effects as described below can likewise be associated with or plugged into sockets 130 to enhance the merchandising presentation.

In the exemplary embodiment, the light stick device 100 includes at least one plug-in socket 130 positioned on at least one side 132 thereof. The socket 130 enables a secondary light source 134 as illustrated in FIG. 8 to connect to at least one side 132 of the light stick device 100. In one embodiment, the secondary light source 134 may include a plurality of LEDs 136, as illustrated in FIG. 8, and at least one deflector as discussed above in connection with light stick 100. In this embodiment, light source 134 may be a light stick in and of itself, or any other construction capable of holding a plurality of LEDs 136 or other light units or bulb arrangements. In other embodiments, the secondary light source 134 may include a single light source with any known bulb arrangement including an LED. When connected to the light stick device 100 via the socket 130, the secondary light source 134 is powered by the light stick device 100. Any number of sockets 130 may be associated with one or both opposite sides of the light stick device 100. In addition, any number of sockets 130 may likewise be associated with the secondary light source 134 to power another secondary light source.

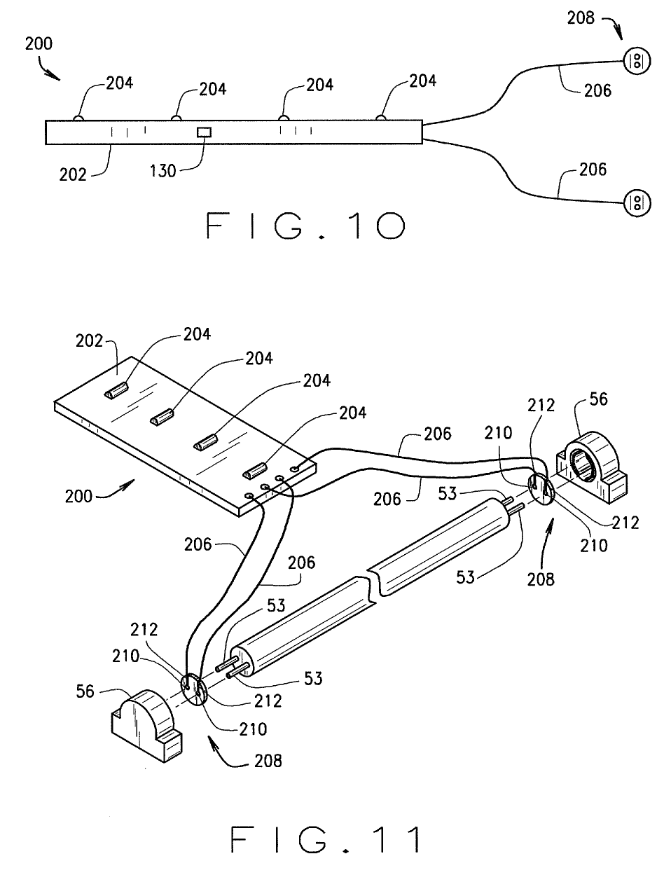

The secondary light source 134 illustrated in FIG. 8 is configured to be selectively attached to a product merchandising rack 30 to highlight particular products. Specifically, it can be attached horizontally to one of the shelf members 36, or it can be attached vertically to an upright support 34 or between shelf members 36. FIG. 9 illustrates several secondary light sources 134 plugged into respective sockets 130 associated with the respective light stick devices 100 and extending horizontally across the access door 26. Light source 134a is attached by conventional means to the underside portion of one of the shelves 36 or to the framework structure associated with product merchandising rack 30 so as to illuminate downwardly onto the products positioned on the shelf below. In similar fashion, another secondary light source 134b is plugged into another light stick socket 130 and is attached by conventional means to the top side portion of one of the shelves 36 or to the framework structure of the rack 30 so as to illuminate upwardly onto the products positioned on the shelf above. Accordingly, the secondary light source 134 can highlight one or more individual products 32 from above the product 32, below the product 32, and/or from the side of the product 32. Other arrangements of the secondary light source and its position and location within the product merchandising rack 30 are likewise envisioned and anticipated.

Still further, in the exemplary embodiment illustrated herein, either the light stick 100 or the secondary light source 134 can provide a plurality of theatrical effects to the cooler door 26. For example, different colored lights, flashing lights, moving lights and/or color fading devices and/or devices that effect dynamic color changes could be used to add effects to the door 26, and the products positioned therebehind. Further, individual lights, spotlights, sequencing lights in a pattern or at random, and changing and/or sequenced colored lights can be used to highlight individual products 32. Moreover, motion detectors, video equipment such as LCD screens, fog machines, audio equipment, beepers, sensor activated devices, sound effect devices for playing sound tracks and sound bites, and more could be added or attached to the light stick device 100 and/or the secondary light source 134 to provide enhanced effects with respect to highlighting the products 32. In essence, the present light stick device 100 can be used as a generic power source to power any type of audio/visual effect apparatus or any other electrical device one may want to add to the cooler doors 26 to increase attention and awareness of the products being offered for sale within the cooler.

Alternatively, the secondary light source 134 may include a solar cell that powers the light source with light from the light stick 100 rather than plugging directly into the socket 130.

As shown in FIG. 10, in one alternate exemplary embodiment, the secondary light source 200 may include a body portion 202 which includes a printed circuit board (not shown) and a plurality of LEDs 204. In this embodiment, secondary light source 200 may be any construction capable of holding a plurality of LEDs 204 or other light units or bulb arrangements. In other embodiments, the secondary light source 200 may include a single light source with any known bulb arrangement including an LED 204. The body portion 202 may include a cover which is positioned over the LEDs 204 to protect the components of the secondary light source 200 from the outside environment. The cover is preferably transparent to allow the light from the LEDs 204 to pass therethrough, or it may include a plurality of openings, each opening adapted to receive an LED 204.

In the embodiment illustrated in FIG. 10, the secondary light source 200 is preferably electrically connected by wire leads 206 to at least one electrical contact wafer 208. Two electrical contact wafers 208 connected by wire leads 206 are shown in FIG. 10. The contact wafers 208 interface with the electrical contacts of existing fluorescent tubes 52 to supply the light source 200 with power. In one embodiment, an electrical contact wafer 208 is shaped and structured to engage a standard fluorescent tube 52 and fit between the fluorescent tube 52 and one of its electrical connection fixtures 56 without causing significant structural or electrical interruption between the fluorescent tube 52 and its electrical connection fixture 56. Where the existing electrical connection fixture 56 provides sufficient power to allow the secondary light source 200 to function with the electricity shared with a fluorescent tube 52 through only one contact wafer 208, a second contact wafer 208 is unnecessary. In addition, the secondary light source 200 may likewise include at least one socket 130 for powering another secondary light source.

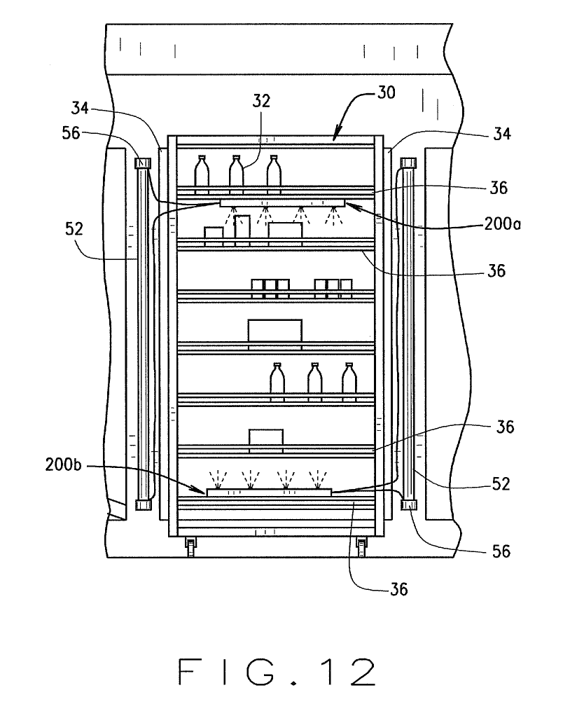

As shown in FIG. 11, preferably two electrical contact wafers 208 are utilized, one interfacing with each end of the fluorescent tube 52 and with a respective electrical connection fixture 56. Each electrical contact wafer 208 includes two through-holes 210 sized, shaped and located to allow the two fluorescent lamp leads 53 at each end of a fluorescent tube 52 to pass through and electrically interface with its respective electrical connection 56. Each wire lead 206 is preferably in electrical communication with an electrical contact 212 in the respective through-holes 210 of an electrical contact wafer 208 as shown in FIG. 11. An electrical contact 212 is in electrical communication with a fluorescent lamp lead 53 when the electrical contact wafer 208 is engaged with the fluorescent tube 52 and the fluorescent lamp leads 53 pass through through-holes 210 of the electrical contact wafer 208. Alternatively, a wire lead 206 may make direct contact with a fluorescent tube lead 53 when the electrical contact wafer 208 is engaged with a fluorescent tube 52. Thus, when power transfers from the electrical connection fixture 56 through the fluorescent lamp leads 53 into the fluorescent tube 52, a portion of such power is shared with or diverted to the secondary light source 200 through the electrical contacts 212 and/or wire leads 206 to the secondary light source 200.

It is also recognized and understood that an electrical contact wafer 208 can be associated with any electrical device for use in any type of product display unit. Such an electrical device may draw power through such an electrical contact wafer 208 to produce theatrical effects such as different colored lights, flashing lights, moving lights and/or lighting color fades, spotlights, sequencing lights, fog, video, audio and more to draw consumer attention to particular products in the product display unit.

It is noted that the electrical contact wafer 208 structure described above is only one embodiment which is designed for engagement with standard fluorescent tubes 52. Other wafer designs would be obvious in view of other bulb designs to one of ordinary skill of the art. Further, in order to ensure power levels are neither too high nor too low, a pack of resistors may be utilized to dissipate some power as heat.

The secondary light source 200 illustrated in FIGS. 10 and 11 is configured to be selectively attached to a product merchandising display unit such as the product display unit 30 illustrated in FIG. 12 to highlight particular products. Specifically, it can be attached horizontally to one of the shelf members 36, or it can be attached vertically to an upright support 34 or between shelf members 36. FIG. 12 illustrates one secondary light source 200a plugged into the electrical connections 56 associated with a fluorescent tube 52 and attached by conventional means to the underside portion of one of the shelves 36 or to the framework structure associated with product merchandising rack 30 so as to illuminate downwardly onto the products positioned on the shelf below. In similar fashion, another secondary light source 200b is plugged into the electrical connections 56 associated with another fluorescent tube 52 and is attached by conventional means to the top side portion of one of the shelves 36 or to the framework structure of the rack 30 so as to illuminate upwardly onto the products positioned on the shelf above. Accordingly, the secondary light source 200 can highlight one or more individual products 32 from above the product 32, below the product 32, and/or from the side of the product 32. In certain applications, were at least one connection fixture 56 provides sufficient power to allow the secondary light source 200 to function and operate with the electricity shared from the fluorescent tube 52 through the use of only one contact wafer 208, if a single contact wafer 208 was associated with each secondary light source 200a and 200b as previously explained, the single contact wafer could be plugged into one of the two electrical connections 56 associated with each fluorescent tube 52 illustrated in FIG. 12.

Thus, there has been shown and described several embodiments of a lighting system for use in association with walk-in type coolers and with other existing product merchandising areas, which system fulfills all of the objects and advantages sought therefore. As various modifications could be made to the exemplary embodiments as described above with reference to the corresponding illustrations without departing from the spirit and scope of the present invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the above disclosures, their equivalents, and the claims which follow.

What is claimed is:

1. A light stick device for use with existing fluorescent fixtures comprising:
a body portion;
an array of light emitting diodes (LEDs) extending along a length of said body portion;
an electrical power connection for supplying power to said LEDs from an existing fluorescent fixture; and
at least one socket for powering a secondary electrical device from said light stick device.

2. The light stick device defined in claim 1 further including at least one deflector positioned between adjacent LEDs.

3. The light stick device defined in claim 1 further including a plurality of deflectors, one of said deflectors being positioned between each LED.

4. The light stick device defined in claim 3 wherein said deflectors are diamond shaped in configuration.

5. The light stick device defined in claim 3 wherein said deflectors are triangular shaped in configuration.

6. The light stick device defined in claim 3 wherein said deflectors deflect light from said LEDs to each of two sides of said light stick device.

7. The light stick device defined in claim 3 wherein said deflectors deflect light from said LEDs to one of two sides of said light stick device.

8. The light stick device defined in claim 1 further including a cover.

9. The light stick device defined in claim 8 wherein said cover includes at least one deflector.

10. The light stick device defined in claim 1 including a plurality of sockets for powering a plurality of secondary electrical devices.

11. The light stick device defined in claim 1 further including a secondary electrical device electrically connected to said light stick device through said socket.

12. The light stick device defined in claim 11 wherein said secondary electrical device is a secondary light source.

13. A light stick device for use with existing fluorescent fixtures comprising:
a body portion;
an array of light emitting diodes (LEDs) extending along a length of said body portion;
at least one deflector positioned to deflect light from at least one of said LEDs;
an electrical power connection for supplying power to said LEDs from an existing fluorescent fixture; and
at least one socket for powering a secondary electrical device from said light stick device.

14. The light stick device defined in claim 13 further including a cover.

15. The light stick device defined in claim 14 wherein said cover includes at least one deflector.

16. The light stick device defined in claim 13 including a plurality of sockets for powering a plurality of secondary electrical devices.

17. The light stick device defined in claim 13 further including a secondary electrical device electrically connected to said light stick device through said socket.

18. The light stick device defined in claim 17 wherein said secondary electrical device is a secondary light source.

19. A light stick device for use with existing fluorescent fixtures comprising:
an array of light emitting diodes (LEDs) configured to illuminate at least a portion of the walk-in cooler;
an array of deflectors, at least one deflector positioned between each adjacent LED to deflect light from said LEDs;
an electrical power connection for interfacing with existing fluorescent fixtures to power said LEDs; and
at least one socket for powering a secondary electrical device from said light stick device.

20. The light stick device defined in claim 19 further including a secondary electrical device electrically connected to said light stick device through said socket.

21. The light stick device in claim 20 wherein said secondary electrical device is a secondary light source for further illuminating selected items.

22. The light stick device defined in claim 20 wherein said secondary electrical device includes at least one socket for powering another secondary light source.

23. A light stick device for use with existing fluorescent fixtures comprising:
a body portion having a generally triangular transverse cross section and two outwardly directed faces;
an array of light emitting diodes (LEDs) extending along a length of each of said outwardly directed faces of said body portion; and
an electrical power connection for supplying power to said LEDs from an existing fluorescent fixture.

24. The light stick device defined in claim 23 further including at least one deflector positioned to deflect light from at least one of said LEDs.

25. The light stick device defined in claim 23 further including a cover having a generally circular transverse cross section, said cover circumscribing the generally transverse triangular cross section of the body portion.

26. The light stick device defined in claim 25 wherein said cover includes at least one deflector for directing light from the LED's in a desired direction.

27. The light stick device defined in claim 23 further including at least one socket for powering a secondary electrical device from said light stick device.

28. A secondary light source for use with an existing lighting source having a light unit and an associated power connection comprising:
a body portion;
an array of light emitting diodes (LEDs) extending along the length of said body portion; and
at least one electrical contact wafer for supplying power to said LEDs from the existing light source, said contact wafer being engageable between the light unit and its associated power connection to draw power from the existing lighting source.

29. The secondary light source defined in claim 28 further including a second electrical contact wafer engageable for engagement between the light unit and a second associated power connection to draw power from said existing light source.

30. The secondary light source defined in claim 28 further including one or more deflectors positioned on said body portion to deflect light from said LEDs.

31. The secondary light source defined in claim 28 further including a cover having at least one deflector associated therewith for directing light from the LED's in a desired direction.

32. The secondary light source defined in claim 28 further including at least one socket for powering a secondary electrical device from said secondary light source.

33. A secondary electrical device for use with an existing lighting source having a light unit and an associated power connection comprising:
means for providing theatrical effects; and
at least one electrical contact wafer for supplying power to said means for providing theatrical effects from the existing light source, said contact wafer being engageable between the light unit and its associated power connection to draw power from the existing lighting source.

34. The secondary electrical device defined in claim 33 further including a second electrical contact wafer engageable for engagement between the light unit and a second associated power connection to draw power from said existing light source.

35. The secondary electrical device defined in claim 33 wherein theatrical effects includes at least one of different colored lights, flashing lights, moving lights, spotlights, sequencing lights, fog, sound and video.

36. The secondary electrical device defined in claim 33 wherein said means for providing electrical effects includes at least one of lights, fog machines, sound effect devices, video equipment and sensor activated devices.

37. The secondary electrical device defined in claim 33 further including at least one socket for powering an additional electrical device from said secondary electrical device.
